(19) United States
(12) Patent Application Publication
(10) Pub. No.: US 2024/0275645 A1
(43) Pub. Date: Aug. 15, 2024

(54) TRANSMIT SIGNAL QUALITY FOR A PROBABILISTICALLY SHAPED MESSAGE

(71) Applicant: QUALCOMM Incorporated, San Diego, CA (US)

(72) Inventors: Wei Yang, San Diego, CA (US); Jing Jiang, San Diego, CA (US); Pinar Sen, San Diego, CA (US)

(21) Appl. No.: 18/168,846

(22) Filed: Feb. 14, 2023

(51) Int. Cl. H04L 25/03; H04W 24/08; H04W 28/06

(52) U.S. Cl. CPC H04L 25/03; H04W 24/08; H04W 28/06

(57) ABSTRACT

Methods, systems, and devices for wireless communications are described. Techniques described herein for a probabilistically shaped message to meet a quality requirement of an empirical probability distribution of the probabilistic shaped message being close to a target probability distribution. The closeness of the empirical probability distribution to the target probability distribution may be measured with a distribution closeness metric that is compared to a threshold. The distribution closeness metric may quantify a difference between the empirical probability distribution and the target probability distribution. Additionally, the distribution closeness metric may quantify a difference between respective moments of one or more orders of the empirical probability distribution and the target probability distribution.

### FIELD OF TECHNOLOGY

The following relates to wireless communications, including transmit signal quality for probabilistically shaped message.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support transmit signal quality for a probabilistically shaped message. For example, the described techniques provide for the probabilistically shaped message to meet a quality requirement of an empirical probability distribution of the probabilistic shaped message being close to a target probability distribution. The closeness of the empirical probability distribution to the target probability distribution may be measured with a distribution closeness metric that is compared to a threshold. The distribution closeness metric may quantify a difference between the empirical probability distribution and the target probability distribution. Additionally, the distribution closeness metric may quantify a difference between respective moments of one or more orders of the empirical probability distribution and the target probability distribution. The threshold may be defined in accordance with parameters of the probabilistic shaped message, such as based on a quantity of modulation symbols in a shaping block, a quantity of bits in a shaping block, a shaping rate, or a modulation order.

A method for wireless communication at a first wireless communication device is described. The method may include performing probabilistic shaping on a set of information bits to generate a set of shaped bits in accordance with a target probability distribution and transmitting, to a second wireless communications device, a shaped message generated based on the set of shaped bits, where a distribution closeness metric between an empirical probability distribution of the shaped message and the target probability distribution satisfies a threshold.

An apparatus for wireless communication at a first wireless communication device is described. The apparatus may include a processor, memory coupled with the processor, and instructions stored in the memory. The instructions may be executable by the processor to cause the apparatus to perform probabilistic shaping on a set of information bits to generate a set of shaped bits in accordance with a target probability distribution and transmit, to a second wireless communications device, a shaped message generated based on the set of shaped bits, where a distribution closeness metric between an empirical probability distribution of the shaped message and the target probability distribution satisfies a threshold.

Another apparatus for wireless communication at a first wireless communication device is described. The apparatus may include means for performing probabilistic shaping on a set of information bits to generate a set of shaped bits in accordance with a target probability distribution and means for transmitting, to a second wireless communications device, a shaped message generated based on the set of shaped bits, where a distribution closeness metric between an empirical probability distribution of the shaped message and the target probability distribution satisfies a threshold.

A non-transitory computer-readable medium storing code for wireless communication at a first wireless communication device is described. The code may include instructions executable by a processor to perform probabilistic shaping on a set of information bits to generate a set of shaped bits in accordance with a target probability distribution and transmit, to a second wireless communications device, a shaped message generated based on the set of shaped bits, where a distribution closeness metric between an empirical probability distribution of the shaped message and the target probability distribution satisfies a threshold.

In some examples of the method, apparatuses, and non-transitory computer-readable medium described herein, the empirical probability distribution may be an empirical probability distribution of the set of shaped bits.

Some examples of the method, apparatuses, and non-transitory computer-readable medium described herein may further include operations, features, means, or instructions for measuring the empirical probability distribution across transmission of one or more shaped messages for a target duration.

Some examples of the method, apparatuses, and non-transitory computer-readable medium described herein may further include operations, features, means, or instructions for modulating the set of shaped bits to generate a set of modulated symbols, where the empirical probability distribution may be an empirical probability distribution of respective amplitudes of the set of modulated symbols.

In some examples of the method, apparatuses, and non-transitory computer-readable medium described herein, the distribution closeness metric quantifies a difference between the empirical probability distribution and the target probability distribution.

In some examples of the method, apparatuses, and non-transitory computer-readable medium described herein, the distribution closeness metric may be a Kullback-Leibler divergence score, an entropy difference, a total variation distance, a Hellinger distance, or a statistical distance.

In some examples of the method, apparatuses, and non-transitory computer-readable medium described herein, the distribution closeness metric quantifies a difference between respective moments of one or more orders of the empirical probability distribution and the target probability distribution.

Some examples of the method, apparatuses, and non-transitory computer-readable medium described herein may further include operations, features, means, or instructions for determining the threshold based on a parameter of the shaped message.

In some examples of the method, apparatuses, and non-transitory computer-readable medium described herein, the parameter may be a number of modulation symbols in a shaping block, a number of bits in a shaping block, a shaping rate, a modulation order, or a combination thereof.

In some examples of the method, apparatuses, and non-transitory computer-readable medium described herein, transmitting the shaped message may include operations, features, means, or instructions for transmitting the shaped message in accordance with a first maximum power reduction (MPR) associated with the shaped message different from a second MPR associated with uniform quadrature amplitude modulation (QAM).

Some examples of the method, apparatuses, and non-transitory computer-readable medium described herein may further include operations, features, means, or instructions for transmitting the shaped message in accordance with a first error vector magnitude (EVM) associated with the shaped message different from a second EVM associated with uniform QAM.

Some examples of the method, apparatuses, and non-transitory computer-readable medium described herein may further include operations, features, means, or instructions for decoding the set of shaped bits, reconstructing a demodulation symbol based in part on the decoded set of shaped bits, and measuring an EVM associated with the shaped message based in part on an equalized probabilistic shaped transmitted waveform and the demodulation symbol.

Some examples of the method, apparatuses, and non-transitory computer-readable medium described herein may further include operations, features, means, or instructions for receiving signaling indicating the distribution closeness metric.

Some examples of the method, apparatuses, and non-transitory computer-readable medium described herein may further include operations, features, means, or instructions for receiving signaling indicating the target probability distribution.

A method for wireless communication at a second wireless communication device is described. The method may include receiving, from a first wireless communication device, a shaped message and outputting a signal indicating whether a distribution closeness metric between an empirical probability distribution of the shaped message and a target probability distribution of the shaped message satisfies a threshold.

An apparatus for wireless communication at a second wireless communication device is described. The apparatus may include a processor, memory coupled with the processor, and instructions stored in the memory. The instructions may be executable by the processor to cause the apparatus to receive, from a first wireless communication device, a shaped message and output a signal indicating whether a distribution closeness metric between an empirical probability distribution of the shaped message and a target probability distribution of the shaped message satisfies a threshold.

Another apparatus for wireless communication at a second wireless communication device is described. The apparatus may include means for receiving, from a first wireless communication device, a shaped message and means for outputting a signal indicating whether a distribution closeness metric between an empirical probability distribution of the shaped message and a target probability distribution of the shaped message satisfies a threshold.

A non-transitory computer-readable medium storing code for wireless communication at a second wireless communication device is described. The code may include instructions executable by a processor to receive, from a first wireless communication device, a shaped message and output a signal indicating whether a distribution closeness metric between an empirical probability distribution of the shaped message and a target probability distribution of the shaped message satisfies a threshold.

Some examples of the method, apparatuses, and non-transitory computer-readable medium described herein may further include operations, features, means, or instructions for demodulating a set of shaped bits from the shaped message, where the empirical probability distribution may be an empirical probability distribution of the set of shaped bits.

Some examples of the method, apparatuses, and non-transitory computer-readable medium described herein may further include operations, features, means, or instructions for measuring the empirical probability distribution across transmission of one or more shaped messages for a target duration.

In some examples of the method, apparatuses, and non-transitory computer-readable medium described herein, the empirical probability distribution may be an empirical probability distribution of respective amplitudes of a set of modulated symbols of the shaped message.

In some examples of the method, apparatuses, and non-transitory computer-readable medium described herein, the distribution closeness metric quantifies a difference between the empirical probability distribution and the target probability distribution.

In some examples of the method, apparatuses, and non-transitory computer-readable medium described herein, the distribution closeness metric may be a Kullback-Leibler divergence score, an entropy difference, a total variation distance, a Hellinger distance, or a statistical distance.

In some examples of the method, apparatuses, and non-transitory computer-readable medium described herein, the distribution closeness metric quantifies a difference between respective moments of one or more orders of the empirical probability distribution and the target probability distribution.

Some examples of the method, apparatuses, and non-transitory computer-readable medium described herein may further include operations, features, means, or instructions for determining the threshold based at least in part with a parameter of the shaped message.

In some examples of the method, apparatuses, and non-transitory computer-readable medium described herein, the parameter may be a number of modulation symbols in a shaping block, a number of bits in a shaping block, a shaping rate, a modulation order, or a combination thereof.

Some examples of the method, apparatuses, and non-transitory computer-readable medium described herein may further include operations, features, means, or instructions for receiving signaling indicating the distribution closeness metric.

Some examples of the method, apparatuses, and non-transitory computer-readable medium described herein may further include operations, features, means, or instructions for receiving signaling indicating the target probability distribution.

### BRIEF DESCRIPTION OF THE DRAWINGS

FIG. 1 illustrates an example of a wireless communications system that supports transmit signal quality for probabilistically shaped message in accordance with one or more aspects of the present disclosure.

FIG. 2 illustrates an example of a wireless communications system that supports transmit signal quality for probabilistically shaped message in accordance with one or more aspects of the present disclosure.

FIG. 3 illustrates an example of a channel coding based shaping technique diagram that supports transmit signal quality for probabilistically shaped message in accordance with one or more aspects of the present disclosure.

FIG. 4 illustrates an example of a process flow that supports transmit signal quality for probabilistically shaped message in accordance with one or more aspects of the present disclosure.

FIGS. 5 and 6 illustrate block diagrams of devices that support transmit signal quality for probabilistically shaped message in accordance with one or more aspects of the present disclosure.

FIG. 7 illustrates a block diagram of a communications manager that supports transmit signal quality for probabilistically shaped message in accordance with one or more aspects of the present disclosure.

FIG. 8 illustrates a diagram of a system including a device that supports transmit signal quality for probabilistically shaped message in accordance with one or more aspects of the present disclosure.

FIGS. 9 and 10 illustrate block diagrams of devices that support transmit signal quality for probabilistically shaped message in accordance with one or more aspects of the present disclosure.

FIG. 11 illustrates a block diagram of a communications manager that supports transmit signal quality for probabilistically shaped message in accordance with one or more aspects of the present disclosure.

FIG. 12 illustrates a diagram of a system including a device that supports transmit signal quality for probabilistically shaped message in accordance with one or more aspects of the present disclosure.

FIGS. 13 through 15 illustrate flowcharts showing methods that support transmit signal quality for probabilistically shaped message in accordance with one or more aspects of the present disclosure.

### DETAILED DESCRIPTION

Existing wireless communication systems, such as cellular and Wi-Fi communications systems, may use higher-order modulation schemes (e.g., quadrature amplitude modulation (QAM)) to increase spectral efficiency at high signal-to-noise ratio (SNR) values. In such existing systems, constellation points may be fixed and each constellation point may be used with an equal probability (e.g., a wireless communication device may have an equal probability of selecting a first constellation point and a second constellation point). Probabilistic shaping is a technique to generate non-uniformly distributed constellation points for a modulation scheme, and probabilistic shaping may improve spectral efficiency. One technique for probabilistic shaping may be probabilistic amplitude shaping (PAS), which shapes the amplitudes of constellation points of a modulation scheme while leaving the signs of the constellation points uniformly distributed. Techniques for PAS may include compression based schemes and channel coding based shaping schemes. For probabilistic shaping, a wireless communication device (such as, a user equipment (UE) or a network entity) may transmit a probabilistically shaped message that is expected to conform to a target probability distribution. If the probabilistically shaped message does not conform to the target probability distribution, another wireless communication device may be unable to properly receive and decode the probabilistically shaped message.

The wireless communication device (e.g., UE or network entity) may meet a transmit signal quality requirement of an empirical probability distribution of the probabilistically shaped message being close to the target probability distribution (e.g., the closeness satisfies a threshold). The transmit signal quality requirement may be configured or standardized. The wireless communication device may probabilistically shape information bits to generate a set of shaped bits and modulate the set of shaped bits to generate a set of modulated symbols. The empirical probability distribution for the probabilistically shaped message may be determined based on the set of shaped bits or respective amplitudes of the set of modulation symbols. The empirical probability distribution may be measured across transmissions of one or more probabilistically shaped messages for a target duration.

The closeness of the empirical probability distribution to the target probability distribution may be measured with a distribution closeness metric that is compared to a threshold. The distribution closeness metric quantifies a difference between the empirical probability distribution and the target probability distribution. For example, the distribution closeness metric may be a Kullback-Leibler divergence score, an entropy difference, a total variation distance, a Hellinger distance or a statistical distance. As another example, the distribution closeness metric may quantify a difference between respective moments of one or more orders of the empirical probability distribution and the target probability distribution. In some examples, the threshold may be defined in accordance with parameters of the probabilistically shaped message. For example, the threshold may be defined based on a quantity of modulation symbols in a shaping block, a quantity of bits in a shaping block, a shaping rate, or a modulation order.

Formulating and representing transmit signal quality for a probabilistically shaped message may enable wireless communication devices to reliably communicate using probabilistically shaped messages. The wireless communication devices may be able to properly code and transmit the probabilistically shaped messages, and the wireless communication devices may be able to properly receive and decode the probabilistically shaped message. The probabilistically shaped messages may improve spectral efficiency.

Aspects of the disclosure are initially described in the context of wireless communications systems. Additional aspects of the disclosure are described in the context of a wireless communications system, an example channel coding based shaping technique diagram, and an example process flow. Aspects of the disclosure are further illustrated by and described with reference to apparatus diagrams, system diagrams, and flowcharts that relate to transmit signal quality for probabilistically shaped message.

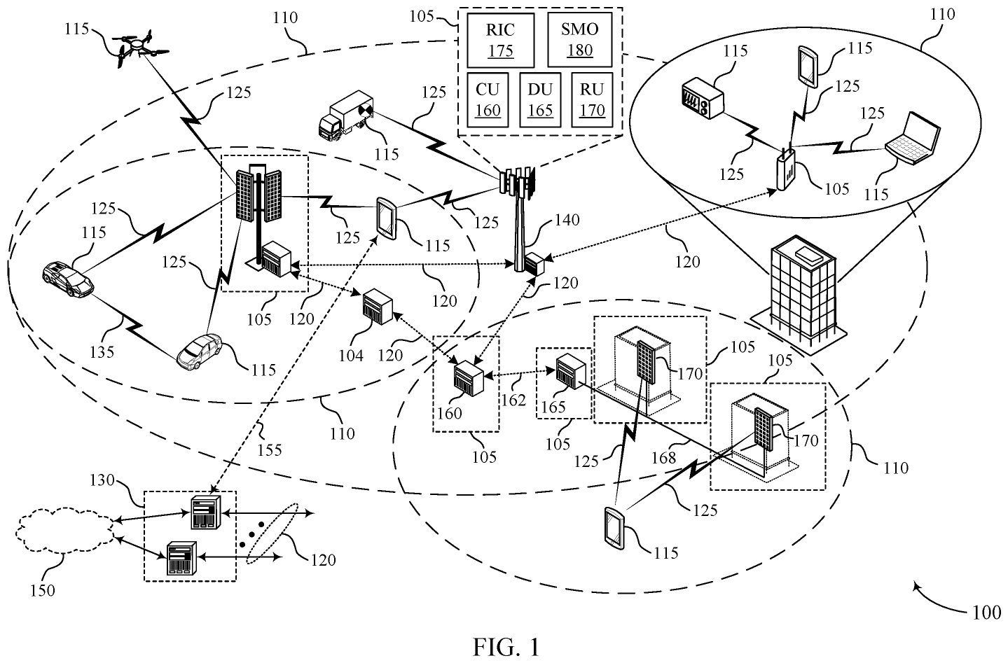

FIG. 1 illustrates an example of a wireless communications system 100 that supports transmit signal quality for probabilistically shaped message in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support transmit signal quality for probabilistically shaped message as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless communication device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Existing wireless communication systems, such as cellular and Wi-Fi communications systems, may use higher-order modulation schemes (e.g., QAM) to increase spectral efficiency at high SNR values. In such existing systems, constellation points of a modulation scheme may be fixed and each constellation point of the modulation scheme may be used with an equal probability (e.g., the wireless communication device may have an equal probability of selecting a first constellation point and a second constellation point of the modulation scheme). Probabilistic shaping is a technique to generate non-uniformly distributed constellation points for a modulation scheme, and probabilistic shaping may improve the spectral efficiency. One technique for probabilistic shaping may be PAS which shapes the amplitudes of constellation points while leaving the signs of the constellation points uniformly distributed. Techniques for PAS may include compression based schemes and channel coding based shaping schemes. For probabilistic shaping, the wireless communication device (e.g., UE 115 or network entity 105) may transmit a probabilistically shaped message that conforms to a target probability distribution. If the probabilistically shaped message does not conform to the target probability distribution, another wireless communication device (e.g., UE 115 or network entity 105) may be unable to properly receive and decode the probabilistically shaped message.

The wireless communication device (e.g., UE 115 or network entity 105) may meet a transmit signal quality requirement of an empirical probability distribution of the probabilistically shaped message being close to the target probability distribution (e.g., satisfies a threshold). The wireless communication device (e.g., UE 115 or network entity 105) may probabilistically shape information bits to generate a set of shaped bits and modulate the set of shaped bits to generate a set of modulated symbols. The empirical probability distribution for the probabilistically shaped message may be determined based on the set of shaped bits or respective amplitudes of the set of modulation symbols. The empirical probability distribution may be measured across transmissions of one or more probabilistically shaped messages for a target duration.

The closeness of the empirical probability distribution to the target probability distribution may be measured with a distribution closeness metric that is compared to a threshold. The distribution closeness metric quantifies a difference between the empirical probability distribution and the target probability distribution. For example, the distribution closeness metric may be a Kullback-Leibler divergence score, an entropy difference, a total variation distance, a Hellinger distance or a statistical distance. As another example, the distribution closeness metric may quantify a difference between respective moments of one or more orders of the empirical probability distribution and the target probability distribution. In some examples, the threshold may be defined in accordance with parameters of the probabilistically shaped message. For example, the threshold may be defined based on a quantity of modulation symbols in a shaping block, a quantity of bits in a shaping block, a shaping rate, or a modulation order.

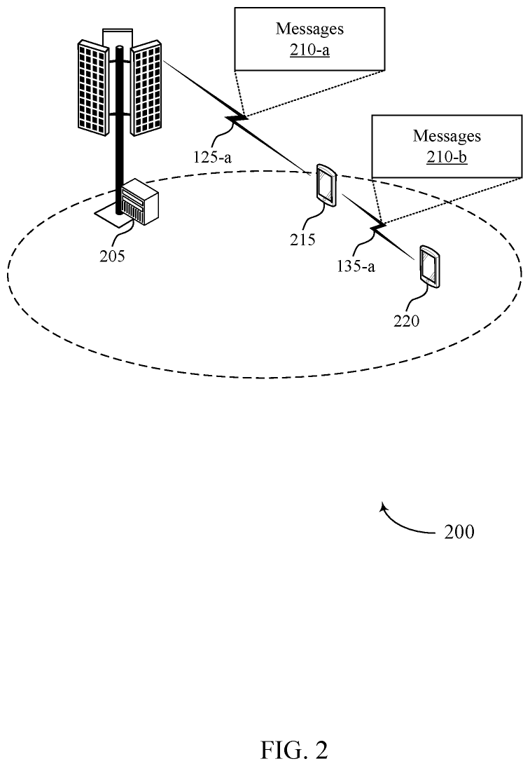

FIG. 2 illustrates an example of a wireless communications system 200 that supports transmit signal quality for probabilistically shaped message in accordance with one or more aspects of the present disclosure. In some examples, wireless communications system 200 may implement aspects of wireless communications system 100. Wireless communications system 200 may include a first wireless communication device 215, a second wireless communication device 220, and a third wireless communication device 205. In some examples, the first wireless communication device 215 and the second wireless communication device 220 may be UEs 115 as described herein. The third wireless communication device 205 may be a network entity 105 as described herein. In some examples, the second wireless communication device 220 may be a test device that determines whether the probabilistically shaped message meets the signal quality requirement.

In some examples, the first wireless communication device 215 may communicate with the third wireless communication device 205 a via a communication link 125-a, and the first wireless communication device 215 may communicate with the second wireless communication device 220 via a communication link 135-a. The communication link 125-a may be an example of the communication link 125, and the communication link 135-a may be an example of the communication link 135, described in reference to FIG. 1. The communication link 125-a may include bi-directional links that enable both the uplink and downlink communication. For example, the first wireless communication device 215 may transmit uplink signals (e.g., uplink transmissions), such as uplink control signals or uplink data signals, to the third wireless communication device 205 using the communication link 125-a and the third wireless communication device 205 may transmit downlink signals (e.g., downlink transmissions), such as downlink control signals or downlink data signals, to the first wireless communication device 215 using the communication link 125-a. In some examples, the communication link 135-a may include bi-direction links that enable sidelink communications. As another example, the first wireless communication device 215 may transmit sidelink signals, such as sidelink control signals or sidelink data signals, to the second wireless communication device 220 using the communication link 135-a.

For example, the first wireless communication device 215 may communicate messages 210-b, such as data transmissions, with the second wireless communication device 220 a via the communication link 135-a, and the first wireless communication device 215 may communicate messages 210-a, such as data transmission, with the third wireless communication device 205 via the communication link 135-a. In some examples, the messages 210-a and the messages 210-b may be probabilistically shaped messages.

In existing wireless communication systems, such as cellular and Wi-Fi, higher-order modulation schemes (e.g., 16QAM, 64QAM and 256QAM) may be used to increase spectral efficiency at high SNR values. In such existing systems, constellation points of the modulation scheme may be fixed (such as, in square constellations) and each constellation point may be used with an equal probability (e.g., the wireless communication device may have an equal probability of selecting a first constellation point and a second constellation point). Probabilistic shaping may be a technique to generate non-uniformly distributed constellation points, and probabilistic shaping may improve the spectral efficiency of the coded modulation. For example, a non-uniformly distributed QAM may achieve higher capacity than uniformly distributed QAM.

One technique for probabilistic shaping may be PAS, which non-uniformly shapes the amplitudes of constellation points while leaving the signs of the constellation points uniformly distributed. Techniques for PAS may include compression based schemes (e.g., constant composition distribution matching (CCDM), Huffman coding or arithmetic coding based compression) and channel coding based shaping schemes, such as reusing a decoder for a channel code to generate a target probability distribution for probabilistic shaping transmissions generated using a particular modulation scheme. For probabilistic shaping, a goal may be to generate non-uniformly distributed constellations for the modulation scheme that may achieve a larger mutual information than uniformly distributed constellations at the same SNR. In some examples, the probabilistic shaper may be also known as distribution matcher. The distribution matcher may encode an information payload of a set of uniform bits into a larger payload of non-uniform bits with a reverse lossless source coding (e.g., reverse arithmetic coding or Hoffman coding).

In some examples, one approach for PAS may be based on source compression techniques, such arithmetic coding and Hoffman coding. For the source compression techniques, the source coding may convert non-uniformly distributed sources into uniform bits which may be the reverse of probabilistic shaping. Some example source compression techniques may include CCDM, multiple composition distribution matching, and sphere shaping. For sphere shaping, the input codeword (e.g., a multi-dimensional complex vector) may be constrained into a power sphere. In some examples, to use PAS based on source compression techniques for the messages 210-a and the messages 210-b, the technique for compressing the information the bits in a bit-exact manner may be specified. For example, the compression algorithm up to fixed-points by quantizing the probability values to a given precision may be specified. For wireless communication systems, the algorithm used for many different configurations may be specified in terms of shaping rate, target probability distribution, block length and modulation order. Additionally, the source code may be non-linear and may be difficult to jointly design with forward error correction. In some examples, new hardware and software may be used to implement high speed compression and decompression.

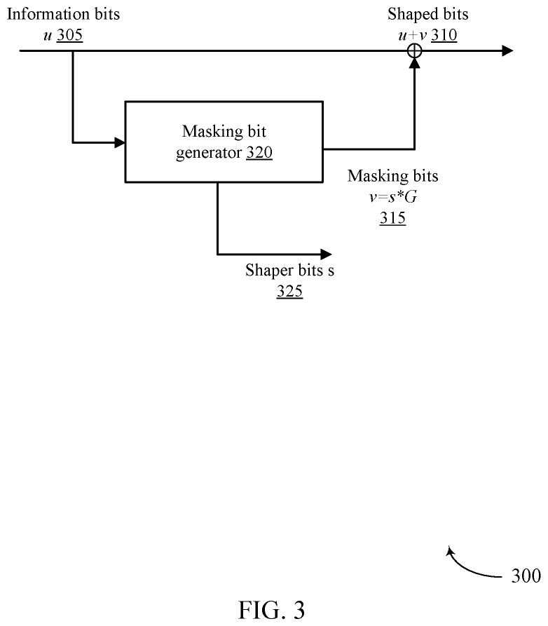

FIG. 3 illustrates an example of a channel coding based shaping technique diagram 300 that supports transmit signal quality for probabilistically shaped message in accordance with one or more aspects of the present disclosure. A channel coding based shaping technique may be another approach for PAS. In some examples, the channel coding based shaping technique illustrated in FIG. 3 may be used to generate probabilistically shaped messages that may be communicated in the wireless communications system 100 and the wireless communications system 200 as described in FIGS. 1 and 2, respectively.

In some examples, the channel coding based shaping technique may be based on block code and bit masking. The channel based shaping technique may be used to perform probabilistic shaping on a set of u information bits 305 to generate a set of u+v shaped bits 310 in accordance with a target probability distribution. In some examples, the v masking bits 315 may be generated with a masking bit generator 320 to provide the u+v shaped bits 310 (bits after masking) having the target probability distribution. The v masking bits 315 may be codewords of a block code generated from a generator matrix G of the block code. In some examples, the v masking bits 315 may be based on the product of s shaper bits 325 and the generator matric G (e.g., v=s*G). In another example, a matcher may directly generate the set of shaped bits from the set of information bits to achieve the target probability distribution without using masking. For these examples, the set of shaped bits may be generated using a decoder for the block code.

For PAS with the channel coding based shaping technique, different wireless communication devices may implement different channel coding based shaping algorithms or different source coding algorithms that may use a common code (e.g., a linear code or a polar code). The different channel coding based shaping algorithms may be implemented by different wireless communication devices similar as different wireless communication devices may implement different channel decoders. Additionally, the different channel coding based shaping algorithms may reuse existing polar code and existing encoder or decoder hardware to perform the probabilistic shaping.

In wireless communications systems, such as the wireless communication system 100 and the wireless communications system 200, the wireless communication device (e.g., first wireless communication device 215, second wireless communication device 220 and third wireless communication device 205) may meet a transmit signal quality requirement. For example, standards may impose various requirements on the waveform or signal or message (such as the radio frequency portion) transmitted by the first wireless communication device 215, second wireless communication device 220 and third wireless communication device 205. Some example requirements may include frequency error, error vector magnitude (EVM), and emission requirements. The first wireless communication device 215, second wireless communication device 220 and third wireless communication device 205 may be expected to meet the transmit signal quality requirements in order to reliably communicate with other wireless communication devices.

Referring to FIG. 2, for the probabilistically shaped message 210-a and the probabilistically shaped message 210-b, different wireless communication devices (e.g., first wireless communication device 215, second wireless communication device 220 and third wireless communication device 205) may implement different probabilistic shaping techniques. For example, different wireless communication devices (e.g., first wireless communication device 215, second wireless communication device 220 and third wireless communication device 205) may use a different decoder for channel coding based shaping. Accordingly, the wireless communication devices (e.g., first wireless communication device 215, second wireless communication device 220 and third wireless communication device 205) may be expected to meet transmit quality requirement for the probabilistically shaped message or signal. If the wireless communication devices (e.g., first wireless communication device 215, second wireless communication device 220 and third wireless communication device 205) do not transmit the probabilistically shaped message conforming to the target probability distribution, the receiving wireless communication device may be unable to property receive and decode the shaped message.

In some examples, the transmit signal quality for the probabilistically shaped messages may be defined, and the first wireless communication device 215, second wireless communication device 220 and third wireless communication device 205 may transmit probabilistically shaped messages that conform to the expected quality. For the probabilistically shaped message having bits or modulations symbols with a target probability distribution Q_{X}, the wireless communication device (e.g., first wireless communication device 215, second wireless communication device 220 and third wireless communication device 205) may transmit probabilistically shaped messages having bits or modulations symbols with an empirical probability distribution P_{X} of the modulated symbols or shaped bits that is close to the target probability distribution Q_{X}.

The empirical probability distribution P_{X} may be a probability mass function defined as

$${P}_{X} ( x ) = \frac{\# Tx modulation symbols equal to x}{n} , ∀ x ∈ S$$

where S denotes the constellation set of the modulation, x denotes a modulation symbol in the set S of modulation symbols. The empirical probability distribution P_{X}(x) may be measured across one or more transmissions of n modulation symbols. For example, the empirical probability distribution P_{X}(x) may be measured across one or more transmissions of one or more probabilistically shaped messages for a target duration. The value of n may be determined by the duration in which the distribution is measured (e.g., 1 slot, 1 ms, 10 ms). The target probability distribution Q_{X}(x) may be defined on the same set of modulations symbols. In another example, the empirical probability distribution P_{X}(x) may be measured on the amplitude of the symbol, such as on |x|. In another example, the empirical probability distribution P_{X}(x) may be measured on the set of shaped or coded bits; distance metrics may be defined similarly on the set of shaped bits (e.g., on joint distribution of b₀, b₁, b₂, . . . ).

In some examples, the distribution closeness metric may be used to quantify the closeness of the empirical probability distribution to the target probability distribution. The distribution closeness metric may indicate the transmit signal quality. In one example, the distribution closeness metric quantifies a difference between the empirical probability distribution and the target probability distribution.

In one example, the distribution closeness metric may be a Kullback-Leibler (KL) divergence score. KL divergence may be defined as

$$D ( {P}_{X} \vert \vert {Q}_{X} ) = {\sum }_{x ∈ s} P ( x ) log ( \frac{{Q}_{X} ( x )}{{P}_{X} ( x )} ) .$$

The KL divergence may measure a closeness between two distributions in terms of entropy or information. The closer the empirical probability distribution is to the KL divergence, the better the empirical probability distribution and the target probability distribution match in terms of information capacity. The KL divergence may expect that when P_{X}(x)=0, then Q_{X}(x)=0 and vice versa.

In another example, the distribution closeness metric may be an entropy difference which may be defined as H(P_{X})−H(Q_{X}), where H(P_{X})=Σ_{x∈S}−P_{X}(x) log P_{X}(x) and H(Q_{X})=Σ_{x∈S}−Q_{X}(x) log Q_{X}(x). H(P_{X}) denotes the entropy of the empirical probability distribution, and H(Q_{X}) denotes the entropy of the target probability distribution.

In a further example, the distribution closeness metric may be a total variation distance which may be defined as

$$δ ( {P}_{X} \vert \vert {Q}_{X} ) = {max}_{x ∈ s} \vert {P}_{X} ( x ) - {Q}_{X} ( x ) \vert .$$

In another example, the distribution closeness metric may be a Hellinger distance which may be defined as

$$H ( {P}_{X} , {Q}_{X} ) = \sqrt{{\sum }_{x ∈ s} {( \sqrt{( {P}_{X} ( x ) )} - \sqrt{( {Q}_{X} ( x ) )} )}^{2}} .$$

In another example, the distribution closeness metric may be a statistical distance (e.g., a chi-squared distance) which may be defined as χ²(P_{X},Q_{X})=Σ_{x∈S} Q_{X}(x)(P_{X}(x)/Q_{X}(x)−1)². The described distribution closeness metrics are example distance metrics or distribution closeness measures, and other metrics or measures may be possible.

In another example, the distribution closeness metric may quantify a difference between respective moments of one or more orders of the empirical probability distribution and the target probability distribution. For example, the distribution closeness metric may be a ratio of a power scaling factor ξ(P_{X})/(Q_{X}), where ξ(P_{X}) denotes the parameter that meets the following power equation ξ·Σ_{x∈S}|x|²P_{X}(x)=1 and where ξ(Q_{X}) denotes the parameter that meets the following power equation ξ·∈_{x∈S}|x|²Q_{X}(x)=1. In additional to the power scaling or second order moment, the distribution closeness metric may be one of the higher order moments of the transmitted shaped message versus the target distribution (e.g., Σ_{P}_{_{X}}(|X|^{p})=Σ_{x∈S}|x|^{p}P_{X}(x) vs E_{Q}_{_{X}}(|X|^{P}), p=3, 4, . . . ). In some cases, one or more of the distance metrics discussed herein may be used to determine transmit signal quality.

In some examples, the first wireless communication device 215, second wireless communication device 220 and third wireless communication device 205 may transmit the shaped messages, and the distribution closeness metric between the empirical probability distribution of the shaped messages and the target probability distribution may satisfy a threshold. The first wireless communication device 215, second wireless communication device 220 and third wireless communication device 205 may be expected to meet the transmit signal quality requirements defined by the distribution closeness metric between the empirical probability distribution and the target probability distribution, in order to reliably communicate with other wireless communication devices. For the examples of the distribution closeness metric being the KL divergence, the entropy difference, the total variation distance, the Hellinger distance, and the statistical distance, the threshold may be a real number. For example, the distribution closeness metric may satisfy the threshold by being smaller than the threshold value. In some examples, each distribution closeness metric may have an associated target threshold. For example, the KL divergence may have an associated threshold value, the entropy distance may have an associated threshold value, the total variation distance may have an associated threshold value, the Hellinger distance may have an associated threshold value, and the statistical distance may have an associated threshold value.

For the examples of the distribution closeness metric quantifying the difference between respective moments of one or more orders of the empirical probability distribution and the target probability distribution, the threshold may be a number of decibels (dB). For example, the distribution closeness metric may satisfy the threshold by being smaller than the threshold number of dB. For example, the ratio between the power (2nd order moment) or higher moments of the target distribution and the transmitted signal distribution (empirical distribution) may be less than X dB (e.g., X=0.5, 1 dB) as defined by

$$\vert 10 \cdot {log}_{10} ( \frac{ξ ( {P}_{X} )}{ξ ( {Q}_{X} )} ) \vert < Xd B .$$

For, the examples of the distribution closeness metric quantifying the difference between respective moments of one or more orders of the empirical probability distribution and the target probability distribution, the threshold may be a percentage. For example, the relative differences in power or higher order moments measured in percentile may be less than X % as defined by

$$( \vert \frac{ξ ( {P}_{X} ) - ξ ( {Q}_{X} )}{ξ ( {Q}_{X} )} \vert ) < X \% .$$

In some examples, the threshold may be based on a parameter of the probabilistically shaped message. For example, different target thresholds may be defined for a same distribution closeness metric depending on a parameter of the probabilistically shaped message. In some examples, the parameter may be one or more of a quantity of modulation symbols in a shaping block, a quantity of bits in a shaping block, a shaping rate, a modulation order, or any combination thereof. In some examples, the parameter may be the modulation order, a shaping parameter (e.g., the shaping rate) or any combination thereof. For example, the threshold may be adjusted based on the quantity of modulation symbols in a shaping block or the quantity of bits in the shaping block. The greater quantity of symbols or bits in one shaping block, the closer the empirical distribution may be to the target distribution, so the threshold value may be smaller. In some examples, the set of information bits may be processed by multiple shaper blocks, in this example, the parameter may be the quantity of symbols produced or taken in for one single shaping block.

In some examples, wireless communication device (e.g., first wireless communication device 215, second wireless communication device 220 and third wireless communication device 205) may determine whether the distribution closeness metric between the empirical probability distribution of the probabilistically shaped message and the target probability distribution satisfies a threshold. For example, the wireless communication device (e.g., first wireless communication device 215, second wireless communication device 220 and third wireless communication device 205) may determine whether the distribution closeness metric satisfies the threshold at least once, such as after startup, periodically, or occasionally. In some examples, the wireless communication device (e.g., first wireless communication device 215, second wireless communication device 220 and third wireless communication device 205) may receive signaling indicating a request to determine whether the distribution closeness metric satisfies the threshold. In another example, the wireless communication device may receive signaling indicating the distribution closeness metric, the threshold, the target probability distribution or a combination thereof.

In some examples, the second wireless communication device 220 may be test equipment that evaluates whether the distribution closeness metric between the empirical probability distribution of a received probabilistically shaped message and the target probability distribution satisfies the threshold. The second wireless communication device 220 may output a signal indicating whether the distribution closeness metric satisfies the threshold. In some examples, the first wireless communication device 215 may receive the signal from the second wireless communication device 220. Additionally, the first wireless communication device 215 may adjust the probabilistically shaped messages such that the distribution closeness metric satisfies the threshold.

In some examples, a maximum power reduction (MPR) or additional MPR may define the maximum power reduction the wireless communication device (e.g., first wireless communication device 215, second wireless communication device 220 and third wireless communication device 205) may perform in order to meet one or more emission conditions (e.g., an emission requirement). For example, different modulation orders (e.g., quadrature phase shift keying (QPSK), 16QAM, 64QAM, 256QAM) may have different MPRs, for example, 256QAM may have higher MPR than 64QAM. One defining factor for the different MPR may be a peak to average power ratio (PAPR) of the waveform. In some examples, the wireless communication device (e.g., first wireless communication device 215, second wireless communication device 220 and third wireless communication device 205) may transmit the shaped message with an MPR different from the MPR associated with uniform QAM. The shaped message may have a different PAPR than uniform QAM. Accordingly, the MPR for the shaped messages may be different from the MPR of the uniform QAM messages.

In some examples, the wireless communication device (e.g., first wireless communication device 215, second wireless communication device 220 and third wireless communication device 205) may transmit the shaped message with an EVM different from an EVM associated with a uniform QAM message. For example, a different EVM target level may be defined for the shaped message than the EVM target level for the uniform QAM message at the same modulation order (e.g., the EVM requirement of the shaped message may be more relaxed compared to the EVM requirement of the uniform QAM message.)

In some examples, the EVM measurement for uniform QAM may be tested with known modulation data (e.g., the transmitted data may be assumed to be known at an EVM analyzer) as

$$EVM = \frac{{\vert X - {X}^{′} \vert}^{2}}{{\vert {X}^{′} \vert}^{2}}$$

for measured signal X and reference X′. For the probabilistically shaped system, the EVM analyzer may not be able to determine the modulation data from the transmitter prior to decoding the data because the transmitter may select the shaping bits or shaping method to generate the desired target probability distribution. In some examples, the EVM for the probabilistically shaped messages may be measured by decoding the data from the channel code, reconstructing the ideal data demodulation symbol i(v) from the decoded data, and comparing the EVM between the equalized waveform z′(v) and the ideal data demodulation symbol i(v) as

$$EVM = \sqrt{\frac{{\sum }_{v = 0 , … , n - 1} {\vert {z}^{′} ( v ) - i ( v ) \vert}^{2}}{n \cdot {P}_{0}}}$$

where denotes P₀=n⁻¹ Σ_{v=0, . . . , n-1}|i(v)|² the average power of the ideal or reference signal, and n denotes a number of data symbols.

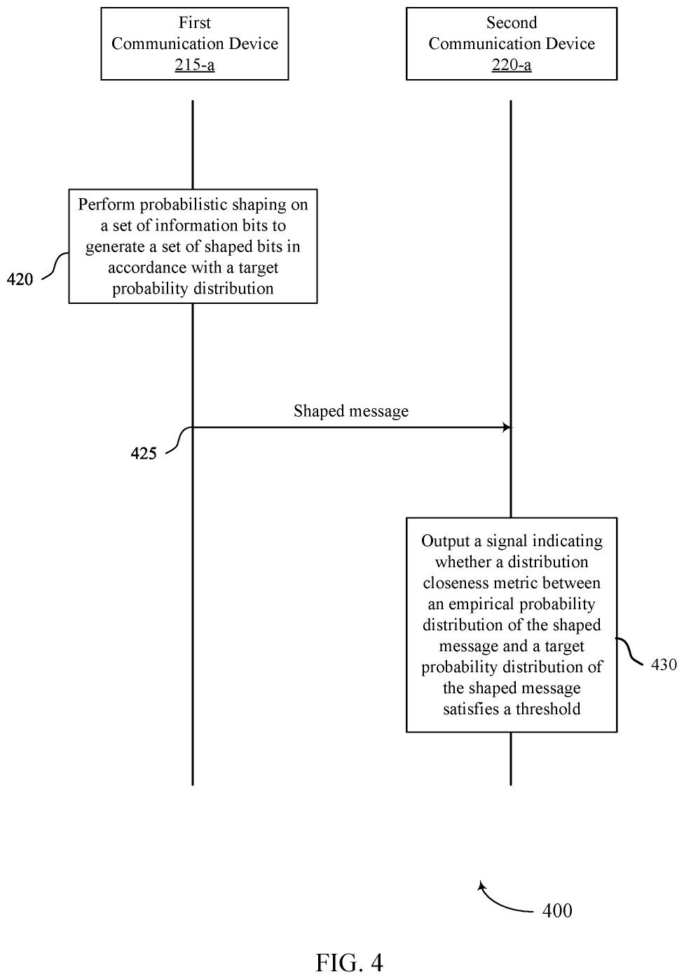

FIG. 4 illustrates an example of a process flow 400 that supports transmit signal quality for probabilistically shaped message in accordance with one or more aspects of the present disclosure. The process flow 400 may include a first wireless communication device 215-a and a second wireless communication device 220-a, which may be an example of the first wireless communication device 215 and the second wireless communication device 220 described herein with respect to FIG. 2. In the following description of the process flow 400, the operations between the first wireless communication device 215-a and the second wireless communication device 220-a may be transmitted in a different order than the example order shown, or the operations performed by the first wireless communication device 215-a and the second wireless communication device 220-a may be performed in different orders or at different times. Some operations may also be omitted from the process flow 400, and other operations may be added to the process flow 400.

At 420, the first wireless communication device 215-a may perform probabilistic shaping on a set of information bits to generate a set of shaped bits in accordance with a target probability distribution.

At 425, the first wireless communication device 215-a may transmit, to the second wireless communication device 220-a, a shaped message generated based on the set of shaped bits. In some examples, a distribution closeness metric between an empirical probability distribution of the shaped message and the target probability distribution may satisfy a threshold.

In some examples, the empirical probability distribution may be an empirical probability distribution of the set of shaped bits. In some examples, the first wireless communication device 215-a may measure the empirical probability distribution across transmission of one or more shaped messages for a target duration.

In some examples, the first wireless communication device 215-a may modulate the set of shaped bits to generate a set of modulated symbols. The empirical probability distribution may be an empirical probability distribution of respective amplitudes of the set of modulated symbols.

In some examples, the distribution closeness metric may quantify a difference between the empirical probability distribution and the target probability distribution. The distribution closeness metric may be a Kullback-Leibler divergence score, an entropy difference, a total variation distance, a Hellinger distance, or a statistical distance. In some examples, the distribution closeness metric may quantify a difference between respective moments of one or more orders of the empirical probability distribution and the target probability distribution.

In some examples, the first wireless communication device 215-a may determine the threshold based on a parameter of the shaped message. The parameter may be a quantity of modulation symbols in a shaping block, a quantity of bits in a shaping block, a shaping rate, a modulation order, or a combination thereof.

In some examples, the first wireless communication device 215-a may transmit the shaped message in accordance with a first MPR associated with the shaped message. The first MPR associated with the shaped message may be different from a second MPR associated with uniform QAM.

In some examples, the first wireless communication device 215-a may transmit the shaped message in accordance with a first EVM associated with the shaped message. The first EVM associated with the shaped message may be different from a second EVM associated with uniform QAM.

In some examples, the first wireless communication device 215-a may decode the set of shape bits and may reconstruct a demodulation symbol based in part on the decoded set of shaped bits. The first wireless communication device 215-a may measure an EVM associated with the shaped message based in part on an equalized probabilistic shaped transmitted waveform and the demodulation symbol.

In some examples, the first wireless communication device 215-a may receive signaling indicating the distribution closeness metric. The first wireless communication device 215-a may receive signaling indicating the target probability distribution

In some examples, the second wireless communication device 220-a may receive, from the first wireless communication device 215-a, the shaped message. At 430, the second wireless communication device 220-a may output outputting a signal indicating whether a distribution closeness metric between an empirical probability distribution of the shaped message and a target probability distribution of the shaped message satisfies a threshold.

In some examples, the second wireless communication device 220-a may demodulate a set of shaped bits from the shaped message. The empirical probability distribution may be an empirical probability distribution of the set of shaped bits.

In some examples, the second wireless communication device 220-a may measure the empirical probability distribution across transmission of one or more shaped messages for a target duration. The empirical probability distribution may be an empirical probability distribution of respective amplitudes of the set of modulated symbols of the shaped message.

In some examples, the second wireless communication device 220-a may determine the threshold based on a parameter of the shaped message. The parameter may be a quantity of modulation symbols in a shaping block, a quantity of bits in a shaping block, a shaping rate, a modulation order, or a combination thereof.

In some examples, the second wireless communication device 220-a may receive signaling indicating the distribution closeness metric. The second wireless communication device 220-a may receive signaling indicating the target probability distribution.

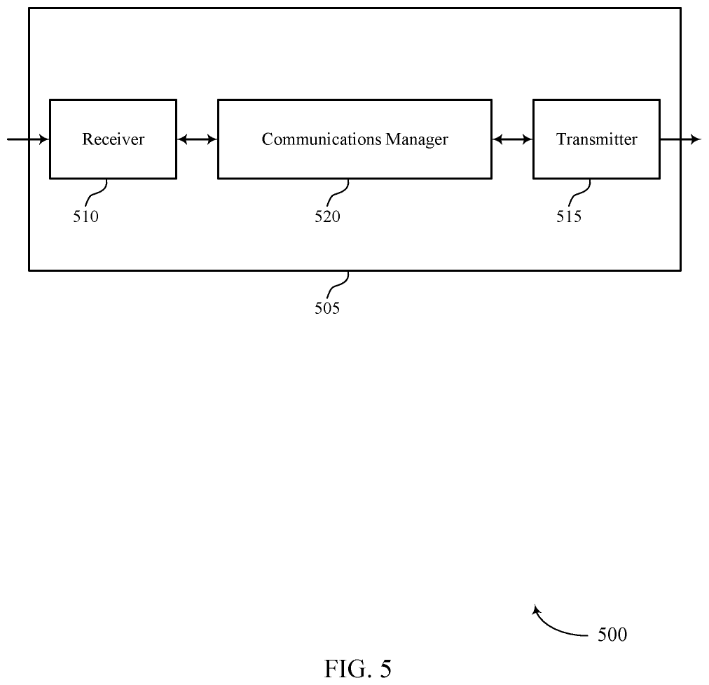

FIG. 5 illustrates a block diagram 500 of a device 505 that supports transmit signal quality for probabilistically shaped message in accordance with one or more aspects of the present disclosure. The device 505 may be an example of aspects of a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of transmit signal quality for probabilistically shaped message as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first wireless communication device in accordance with examples as disclosed herein. For example, the communications manager 520 may be configured as or otherwise support a means for performing probabilistic shaping on a set of information bits to generate a set of shaped bits in accordance with a target probability distribution. The communications manager 520 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

By including or configuring the communications manager 520 in accordance with examples as described herein, the device 505 (e.g., a processor controlling or otherwise coupled with the receiver 510, the transmitter 515, the communications manager 520, or a combination thereof) may support techniques more efficient utilization of communication resources.

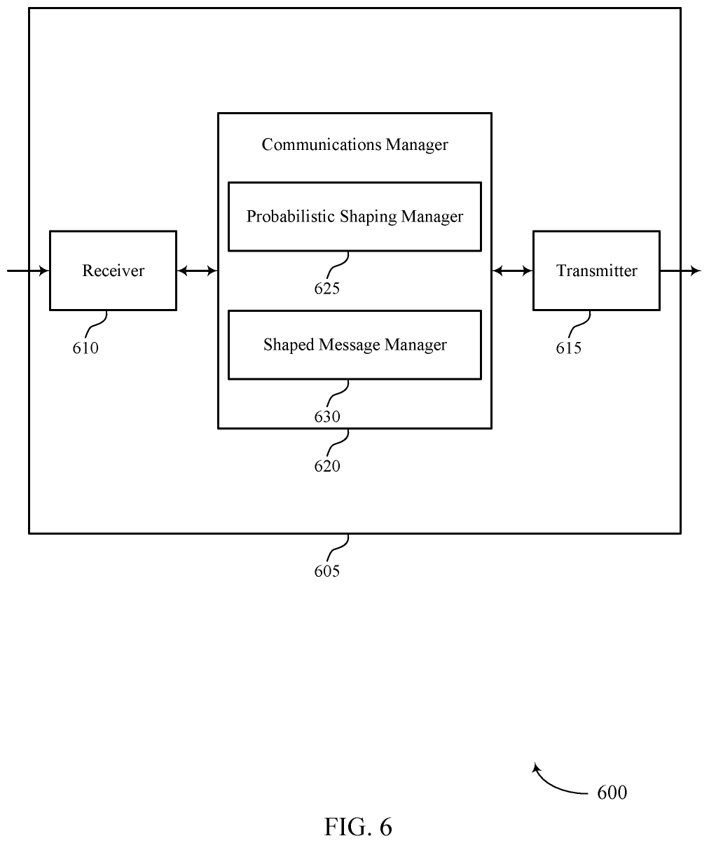

FIG. 6 illustrates a block diagram 600 of a device 605 that supports transmit signal quality for probabilistically shaped message in accordance with one or more aspects of the present disclosure. The device 605 may be an example of aspects of a device 505 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of transmit signal quality for probabilistically shaped message as described herein. For example, the communications manager 620 may include a probabilistic shaping manager 625 a shaped message manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first wireless communication device in accordance with examples as disclosed herein. The probabilistic shaping manager 625 may be configured as or otherwise support a means for performing probabilistic shaping on a set of information bits to generate a set of shaped bits in accordance with a target probability distribution. The shaped message manager 630 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

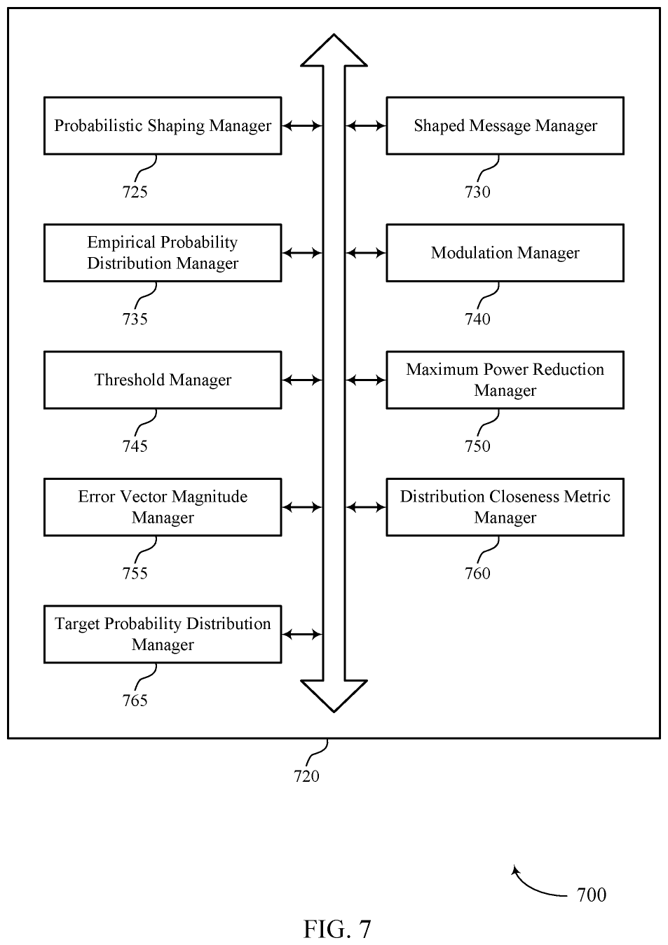

FIG. 7 illustrates a block diagram 700 of a communications manager 720 that supports transmit signal quality for probabilistically shaped message in accordance with one or more aspects of the present disclosure. The communications manager 720 may be an example of aspects of a communications manager 520, a communications manager 620, or both, as described herein. The communications manager 720, or various components thereof, may be an example of means for performing various aspects of transmit signal quality for probabilistically shaped message as described herein. For example, the communications manager 720 may include a probabilistic shaping manager 725, a shaped message manager 730, an empirical probability distribution manager 735, a modulation manager 740, a threshold manager 745, a maximum power reduction manager 750, an error vector magnitude manager 755, a distribution closeness metric manager 760, a target probability distribution manager 765, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communication at a first wireless communication device in accordance with examples as disclosed herein. The probabilistic shaping manager 725 may be configured as or otherwise support a means for performing probabilistic shaping on a set of information bits to generate a set of shaped bits in accordance with a target probability distribution. The shaped message manager 730 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

In some examples, the empirical probability distribution is an empirical probability distribution of the set of shaped bits.

In some examples, the empirical probability distribution manager 735 may be configured as or otherwise support a means for measuring the empirical probability distribution across transmission of one or more shaped messages for a target duration.

In some examples, the modulation manager 740 may be configured as or otherwise support a means for modulating the set of shaped bits to generate a set of modulated symbols, where the empirical probability distribution is an empirical probability distribution of respective amplitudes of the set of modulated symbols.

In some examples, the distribution closeness metric quantifies a difference between the empirical probability distribution and the target probability distribution.

In some examples, the distribution closeness metric is a Kullback-Leibler divergence score, an entropy difference, a total variation distance, a Hellinger distance, or a statistical distance.

In some examples, the distribution closeness metric quantifies a difference between respective moments of one or more orders of the empirical probability distribution and the target probability distribution.

In some examples, the threshold manager 745 may be configured as or otherwise support a means for determining the threshold based on a parameter of the shaped message.

In some examples, the parameter is a quantity of modulation symbols in a shaping block, a quantity of bits in a shaping block, a shaping rate, a modulation order, or a combination thereof.

In some examples, to support transmitting the shaped message, the maximum power reduction manager 750 may be configured as or otherwise support a means for transmitting the shaped message in accordance with a first MPR associated with the shaped message different from a second MPR associated with uniform QAM.

In some examples, the error vector magnitude manager 755 may be configured as or otherwise support a means for transmitting the shaped message in accordance with a first EVM associated with the shaped message different from a second EVM associated with uniform QAM.

In some examples, the error vector magnitude manager 755 may be configured as or otherwise support a means for decoding the set of shaped bits. In some examples, the empirical probability distribution manager 735 may be configured as or otherwise support a means for reconstructing a demodulation symbol based in part on the decoded set of shaped bits. In some examples, the empirical probability distribution manager 735 may be configured as or otherwise support a means for measuring an EVM associated with the shaped message based in part on an equalized probabilistic shaped transmitted waveform and the demodulation symbol.

In some examples, the distribution closeness metric manager 760 may be configured as or otherwise support a means for receiving signaling indicating the distribution closeness metric.

In some examples, the target probability distribution manager 765 may be configured as or otherwise support a means for receiving signaling indicating the target probability distribution.

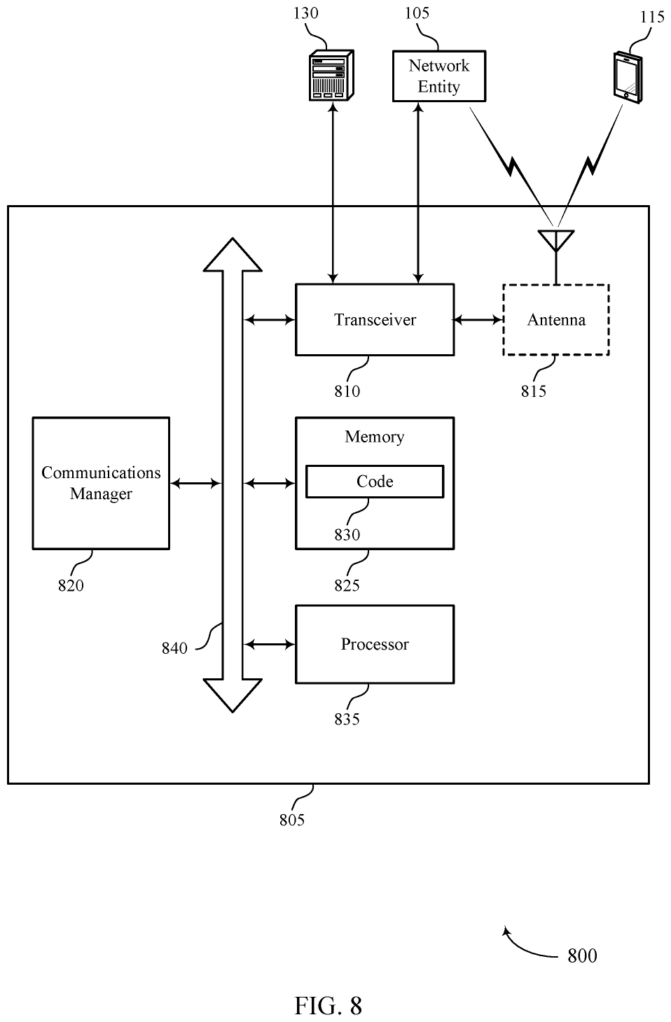

FIG. 8 illustrates a diagram of a system 800 including a device 805 that supports transmit signal quality for probabilistically shaped message in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or memory components (for example, the processor 835, or the memory 825, or both), may be included in a chip or chip assembly that is installed in the device 805. In some examples, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting transmit signal quality for probabilistically shaped message). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805. The processor 835 may be any one or more suitable processors capable of executing scripts or instructions of one or more software programs stored in the device 805 (such as within the memory 825). In some implementations, the processor 835 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 835, or the transceiver 810, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 805 may transmit information output from the chip or modem. Additionally, or alternatively, in some implementations, the one or more interfaces may refer to an interface between the processing system of the chip or modem and a receiver, such that the device 805 may obtain information or signal inputs, and the information may be passed to the processing system. A person having ordinary skill in the art will readily recognize that a first interface also may obtain information or signal inputs, and a second interface also may output information or signal outputs.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with ULEs 115 in cooperation with other network entities 105. In some examples, the communications manager 820 may support an X2 interface within an LTE/LTE-A wireless communications network technology to provide communication between network entities 105.

The communications manager 820 may support wireless communication at a first wireless communication device in accordance with examples as disclosed herein. For example, the communications manager 820 may be configured as or otherwise support a means for performing probabilistic shaping on a set of information bits to generate a set of shaped bits in accordance with a target probability distribution. The communications manager 820 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, the processor 835, the memory 825, the code 830, or any combination thereof. For example, the communications manager 820 may be configured to receive or transmit messages or other signaling as described herein via the transceiver 810. For example, the code 830 may include instructions executable by the processor 835 to cause the device 805 to perform various aspects of transmit signal quality for probabilistically shaped message as described herein, or the processor 835 and the memory 825 may be otherwise configured to perform or support such operations.

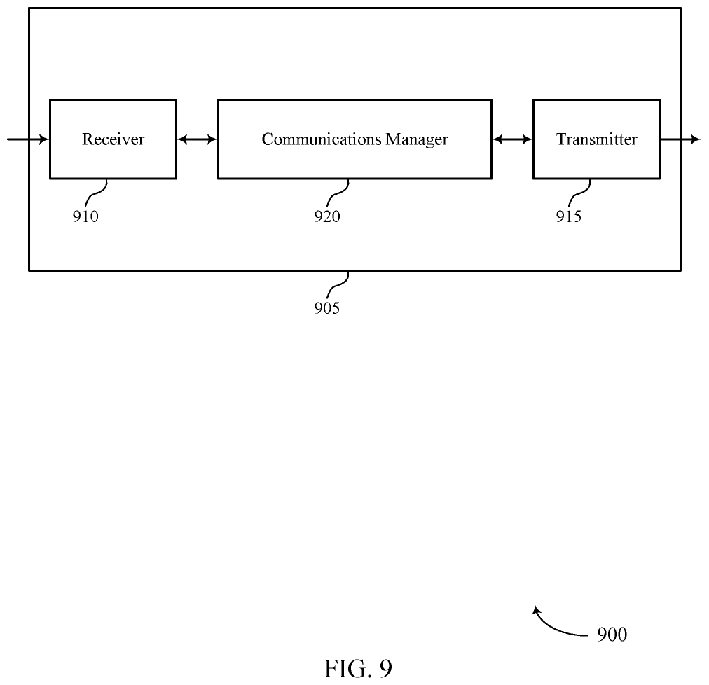

FIG. 9 illustrates a block diagram 900 of a device 905 that supports transmit signal quality for probabilistically shaped message in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to transmit signal quality for probabilistically shaped message). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to transmit signal quality for probabilistically shaped message). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of transmit signal quality for probabilistically shaped message as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first wireless communication device in accordance with examples as disclosed herein. For example, the communications manager 920 may be configured as or otherwise support a means for performing probabilistic shaping on a set of information bits to generate a set of shaped bits in accordance with a target probability distribution. The communications manager 920 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

Additionally, or alternatively, the communications manager 920 may support wireless communication at a second wireless communication device in accordance with examples as disclosed herein. For example, the communications manager 920 may be configured as or otherwise support a means for receiving, from a first wireless communication device, a shaped message. The communications manager 920 may be configured as or otherwise support a means for outputting a signal indicating whether a distribution closeness metric between an empirical probability distribution of the shaped message and a target probability distribution of the shaped message satisfies a threshold.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

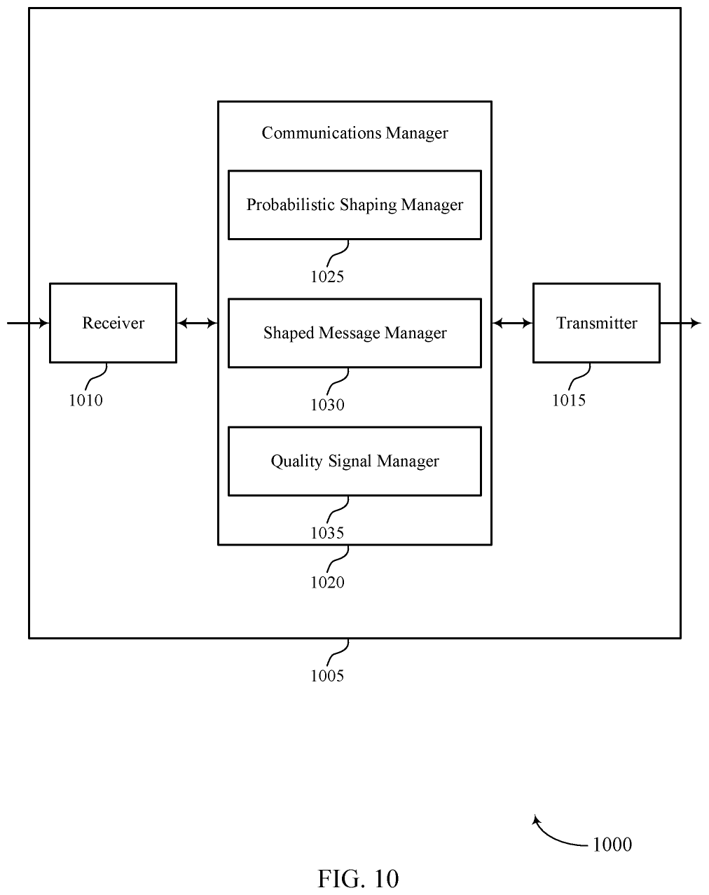

FIG. 10 illustrates a block diagram 1000 of a device 1005 that supports transmit signal quality for probabilistically shaped message in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to transmit signal quality for probabilistically shaped message). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to transmit signal quality for probabilistically shaped message). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of transmit signal quality for probabilistically shaped message as described herein. For example, the communications manager 1020 may include a probabilistic shaping manager 1025, a shaped message manager 1030, a quality signal manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first wireless communication device in accordance with examples as disclosed herein. The probabilistic shaping manager 1025 may be configured as or otherwise support a means for performing probabilistic shaping on a set of information bits to generate a set of shaped bits in accordance with a target probability distribution. The shaped message manager 1030 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

Additionally, or alternatively, the communications manager 1020 may support wireless communication at a second wireless communication device in accordance with examples as disclosed herein. The shaped message manager 1030 may be configured as or otherwise support a means for receiving, from a first wireless communication device, a shaped message. The quality signal manager 1035 may be configured as or otherwise support a means for outputting a signal indicating whether a distribution closeness metric between an empirical probability distribution of the shaped message and a target probability distribution of the shaped message satisfies a threshold.

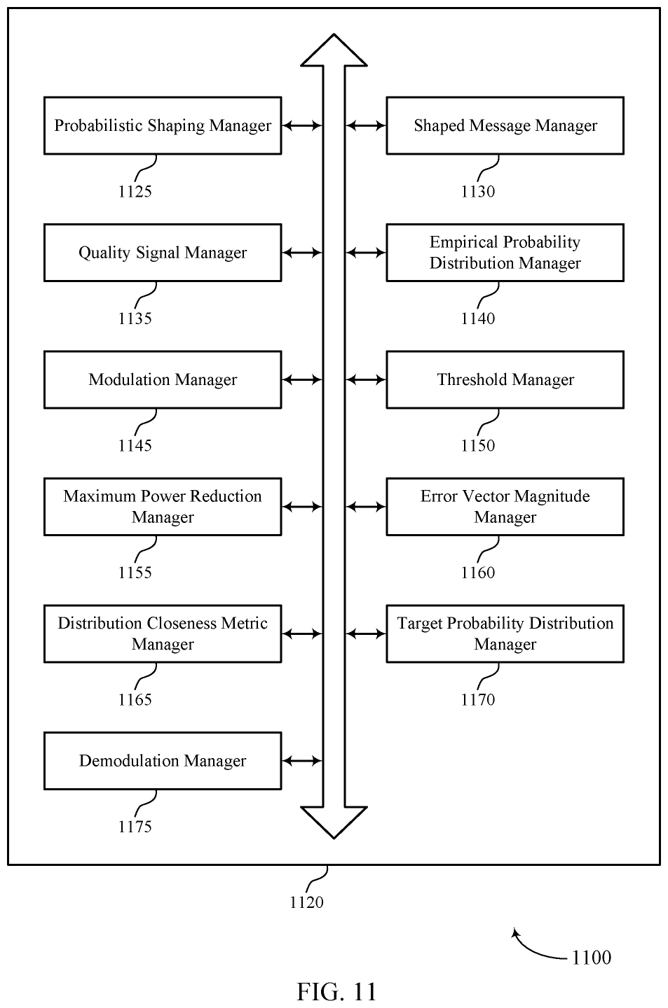

FIG. 11 illustrates a block diagram 1100 of a communications manager 1120 that supports transmit signal quality for probabilistically shaped message in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of transmit signal quality for probabilistically shaped message as described herein. For example, the communications manager 1120 may include a probabilistic shaping manager 1125, a shaped message manager 1130, a quality signal manager 1135, an empirical probability distribution manager 1140, a modulation manager 1145, a threshold manager 1150, a maximum power reduction manager 1155, an error vector magnitude manager 1160, a distribution closeness metric manager 1165, a target probability distribution manager 1170, a demodulation manager 1175, or any combination thereof. Each of these components may communicate, directly or indirectly, with one another (e.g., via one or more buses).

The communications manager 1120 may support wireless communication at a first wireless communication device in accordance with examples as disclosed herein. The probabilistic shaping manager 1125 may be configured as or otherwise support a means for performing probabilistic shaping on a set of information bits to generate a set of shaped bits in accordance with a target probability distribution. The shaped message manager 1130 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

In some examples, the empirical probability distribution is an empirical probability distribution of the set of shaped bits.

In some examples, the empirical probability distribution manager 1140 may be configured as or otherwise support a means for measuring the empirical probability distribution across transmission of one or more shaped messages for a target duration.

In some examples, the modulation manager 1145 may be configured as or otherwise support a means for modulating the set of shaped bits to generate a set of modulated symbols, where the empirical probability distribution is an empirical probability distribution of respective amplitudes of the set of modulated symbols.

In some examples, the distribution closeness metric quantifies a difference between the empirical probability distribution and the target probability distribution.

In some examples, the distribution closeness metric is a Kullback-Leibler divergence score, an entropy difference, a total variation distance, a Hellinger distance, or a statistical distance.

In some examples, the distribution closeness metric quantifies a difference between respective moments of one or more orders of the empirical probability distribution and the target probability distribution.

In some examples, the threshold manager 1150 may be configured as or otherwise support a means for determining the threshold based on a parameter of the shaped message.

In some examples, the parameter is a quantity of modulation symbols in a shaping block, a quantity of bits in a shaping block, a shaping rate, a modulation order, or a combination thereof.

In some examples, to support transmitting the shaped message, the maximum power reduction manager 1155 may be configured as or otherwise support a means for transmitting the shaped message in accordance with a first MPR associated with the shaped message different from a second MPR associated with uniform QAM.

In some examples, the error vector magnitude manager 1160 may be configured as or otherwise support a means for transmitting the shaped message in accordance with a first EVM associated with the shaped message different from a second EVM associated with uniform QAM.

In some examples, the error vector magnitude manager 1160 may be configured as or otherwise support a means for decoding the set of shaped bits. In some examples, the empirical probability distribution manager 1140 may be configured as or otherwise support a means for reconstructing a demodulation symbol based in part on the decoded set of shaped bits. In some examples, the empirical probability distribution manager 1140 may be configured as or otherwise support a means for measuring an EVM associated with the shaped message based in part on an equalized probabilistic shaped transmitted waveform and the demodulation symbol.

In some examples, the distribution closeness metric manager 1165 may be configured as or otherwise support a means for receiving signaling indicating the distribution closeness metric.

In some examples, the target probability distribution manager 1170 may be configured as or otherwise support a means for receiving signaling indicating the target probability distribution.

Additionally, or alternatively, the communications manager 1120 may support wireless communication at a second wireless communication device in accordance with examples as disclosed herein. In some examples, the shaped message manager 1130 may be configured as or otherwise support a means for receiving, from a first wireless communication device, a shaped message. The quality signal manager 1135 may be configured as or otherwise support a means for outputting a signal indicating whether a distribution closeness metric between an empirical probability distribution of the shaped message and a target probability distribution of the shaped message satisfies a threshold.

In some examples, the demodulation manager 1175 may be configured as or otherwise support a means for demodulating a set of shaped bits from the shaped message, where the empirical probability distribution is an empirical probability distribution of the set of shaped bits.

In some examples, the empirical probability distribution manager 1140 may be configured as or otherwise support a means for measuring the empirical probability distribution across transmission of one or more shaped messages for a target duration.

In some examples, the empirical probability distribution is an empirical probability distribution of respective amplitudes of a set of modulated symbols of the shaped message.

In some examples, the distribution closeness metric is a Kullback-Leibler divergence score, an entropy difference, a total variation distance, a Hellinger distance, or a statistical distance.

In some examples, the distribution closeness metric quantifies a difference between the empirical probability distribution and the target probability distribution.

In some examples, the distribution closeness metric quantifies a difference between respective moments of one or more orders of the empirical probability distribution and the target probability distribution.

In some examples, the threshold manager 1150 may be configured as or otherwise support a means for determining the threshold based at least in part with a parameter of the shaped message.

In some examples, the parameter is a quantity of modulation symbols in a shaping block, a quantity of bits in a shaping block, a shaping rate, a modulation order, or a combination thereof.

In some examples, the distribution closeness metric manager 1165 may be configured as or otherwise support a means for receiving signaling indicating the distribution closeness metric.

In some examples, the target probability distribution manager 1170 may be configured as or otherwise support a means for receiving signaling indicating the target probability distribution.

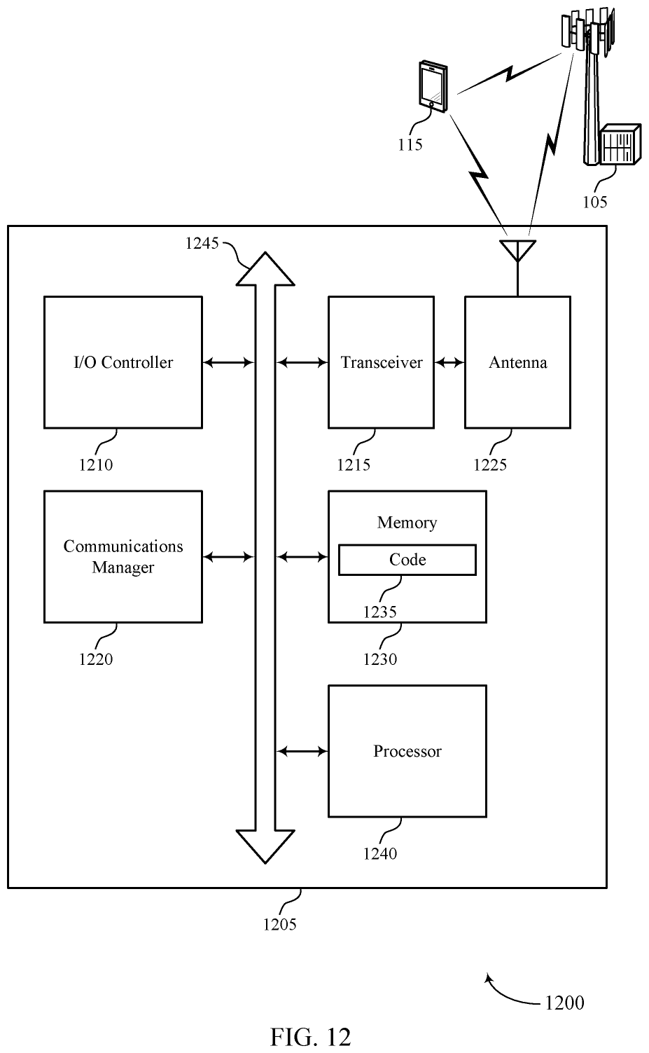

FIG. 12 illustrates a diagram of a system 1200 including a device 1205 that supports transmit signal quality for probabilistically shaped message in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting transmit signal quality for probabilistically shaped message). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a first wireless communication device in accordance with examples as disclosed herein. For example, the communications manager 1220 may be configured as or otherwise support a means for performing probabilistic shaping on a set of information bits to generate a set of shaped bits in accordance with a target probability distribution. The communications manager 1220 may be configured as or otherwise support a means for transmitting, to a second wireless communications device, a shaped message generated based on the set of shaped bits, where a distribution closeness metric between an empirical probability distribution of the shaped message and the target probability distribution satisfies a threshold.

Additionally, or alternatively, the communications manager 1220 may support wireless communication at a second wireless communication device in accordance with examples as disclosed herein. For example, the communications manager 1220 may be configured as or otherwise support a means for receiving, from a first wireless communication device, a shaped message. The communications manager 1220 may be configured as or otherwise support a means for outputting a signal indicating whether a distribution closeness metric between an empirical probability distribution of the shaped message and a target probability distribution of the shaped message satisfies a threshold.

By including or configuring the communications manager 1220 in accordance with examples as described herein, the device 1205 may support techniques for improved communication reliability, reduced latency, more efficient utilization of communication resources and improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. For example, the communications manager 1120 may be configured to receive or transmit messages or other signaling as described herein via the transceiver 1215. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of transmit signal quality for probabilistically shaped message as described herein, or the processor 1240 and the memory 1230 may be otherwise configured to perform or support such operations.

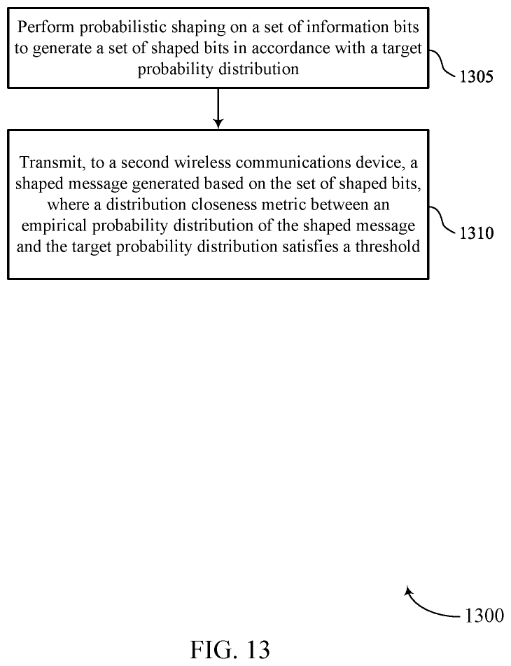

FIG. 13 illustrates a flowchart showing a method 1300 that supports transmit signal quality for probabilistically shaped message in accordance with one or more aspects of the present disclosure. The operations of the method 1300 may be implemented by a network entity or a UE or its components as described herein. For example, the operations of the method 1300 may be performed by a network entity as described with reference to FIGS. 1 through 8 or a UE 115 as described with reference to FIGS. 1 through 4 and 9 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1305, the method may include performing probabilistic shaping on a set of information bits to generate a set of shaped bits in accordance with a target probability distribution. The operations of 1305 may be performed in accordance with examples as disclosed herein. In some examples, aspects of the operations of 1305 may be performed by a probabilistic shaping manager 725 or a probabilistic shaping manager 1125 as described with reference to FIGS. 7 and 11. Additionally, or alternatively, means for performing 1305 may, but not necessarily, include, for example, antenna 815, transceiver 810, communications manager 820, memory 825 (including code 830), processor 835 and/or bus 840.

At 1310, the method may include transmitting, to a second wireless communications device, a shaped message generated based on the set of shaped bits, where a distribution closeness metric between an empirical probability distribution of the shaped message and the target probability distribution satisfies a threshold. In some examples, the transmitting device may be expected to ensure that the distribution closeness metric between the empirical probability distribution and the target probability distribution satisfies the threshold when generating the shaped signal. The operations of 1310 may be performed in accordance with examples as disclosed herein. In some examples, aspects of the operations of 1310 may be performed by a shaped message manager 730 or a shaped message manager 1130 as described with reference to FIGS. 7 and 11. Additionally, or alternatively, means for performing 1310 may, but not necessarily, include, for example, antenna 815, transceiver 810, communications manager 820, memory 825 (including code 830), processor 835 and/or bus 840.

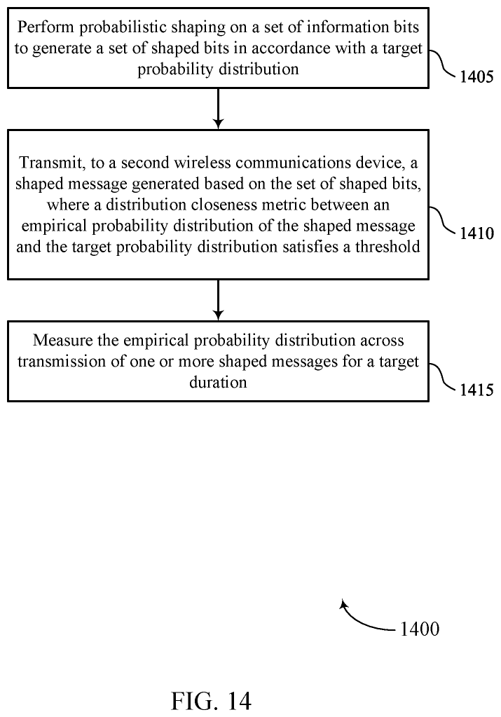

FIG. 14 illustrates a flowchart showing a method 1400 that supports transmit signal quality for probabilistically shaped message in accordance with one or more aspects of the present disclosure. The operations of the method 1400 may be implemented by a network entity or a UE or its components as described herein. For example, the operations of the method 1400 may be performed by a network entity as described with reference to FIGS. 1 through 8 or a UE 115 as described with reference to FIGS. 1 through 4 and 9 through 12. In some examples, a network entity or a UE may execute a set of instructions to control the functional elements of the network entity or the UE to perform the described functions. Additionally, or alternatively, the network entity or the UE may perform aspects of the described functions using special-purpose hardware.

At 1405, the method may include performing probabilistic shaping on a set of information bits to generate a set of shaped bits in accordance with a target probability distribution. The operations of 1405 may be performed in accordance with examples as disclosed herein. In some examples, aspects of the operations of 1405 may be performed by a probabilistic shaping manager 725 or a probabilistic shaping manager 1125 as described with reference to FIGS. 7 and 11. Additionally, or alternatively, means for performing 1305 may, but not necessarily, include, for example, antenna 815, transceiver 810, communications manager 820, memory 825 (including code 830), processor 835 and/or bus 840.

At 1410, the method may include transmitting, to a second wireless communications device, a shaped message generated based on the set of shaped bits, where a distribution closeness metric between an empirical probability distribution of the shaped message and the target probability distribution satisfies a threshold. The operations of 1410 may be performed in accordance with examples as disclosed herein. In some examples, aspects of the operations of 1410 may be performed by a shaped message manager 730 or a shaped message manager 1130 as described with reference to FIGS. 7 and 11. Additionally, or alternatively, means for performing 1305 may, but not necessarily, include, for example, antenna 815, transceiver 810, communications manager 820, memory 825 (including code 830), processor 835 and/or bus 840.

At 1415, the method may include measuring the empirical probability distribution across transmission of one or more shaped messages for a target duration. The operations of 1415 may be performed in accordance with examples as disclosed herein. In some examples, aspects of the operations of 1415 may be performed by an empirical probability distribution manager 735 or an empirical probability distribution manager 1140 as described with reference to FIGS. 7 and 11. Additionally, or alternatively, means for performing 1305 may, but not necessarily, include, for example, antenna 815, transceiver 810, communications manager 820, memory 825 (including code 830), processor 835 and/or bus 840.

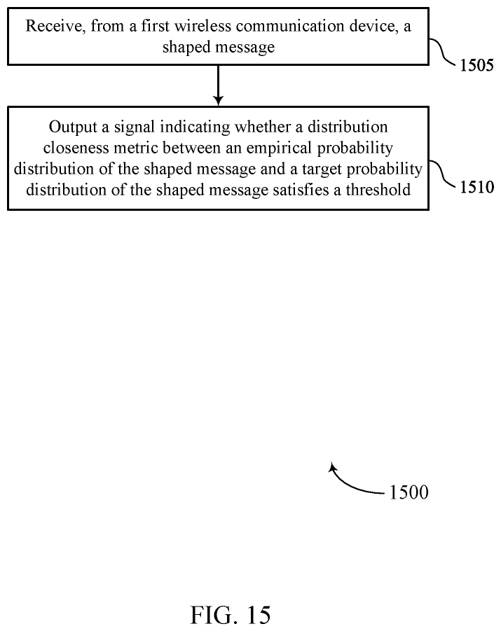

FIG. 15 illustrates a flowchart showing a method 1500 that supports transmit signal quality for probabilistically shaped message in accordance with one or more aspects of the present disclosure. The operations of the method 1500 may be implemented by a UE or its components as described herein. For example, the operations of the method 1500 may be performed by a UE 115 as described with reference to FIGS. 1 through 4 and 9 through 12. In some examples, a UE may execute a set of instructions to control the functional elements of the UE to perform the described functions. Additionally, or alternatively, the UE may perform aspects of the described functions using special-purpose hardware.

At 1505, the method may include receiving, from a first wireless communication device, a shaped message. The operations of 1505 may be performed in accordance with examples as disclosed herein. In some examples, aspects of the operations of 1505 may be performed by a shaped message manager 1130 as described with reference to FIG. 11. Additionally, or alternatively, means for performing 1405 may, but not necessarily, include, for example, antenna 1225, transceiver 1215, communications manager 1220, memory 1230 (including code 1235), processor 1240 and/or bus 1245.

At 1510, the method may include outputting a signal indicating whether a distribution closeness metric between an empirical probability distribution of the shaped message and a target probability distribution of the shaped message satisfies a threshold. The operations of 1510 may be performed in accordance with examples as disclosed herein. In some examples, aspects of the operations of 1510 may be performed by a quality signal manager 1135 as described with reference to FIG. 11. Additionally, or alternatively, means for performing 1405 may, but not necessarily, include, for example, antenna 1225, transceiver 1215, communications manager 1220, memory 1230 (including code 1235), processor 1240 and/or bus 1245.

The following provides an overview of aspects of the present disclosure:

Aspect 1: A method for wireless communication at a first wireless communication device, comprising: performing probabilistic shaping on a set of information bits to generate a set of shaped bits in accordance with a target probability distribution; and transmitting, to a second wireless communications device, a shaped message generated based at least in part on the set of shaped bits, wherein a distribution closeness metric between an empirical probability distribution of the shaped message and the target probability distribution satisfies a threshold.

Aspect 2: The method of aspect 1, wherein the empirical probability distribution is an empirical probability distribution of the set of shaped bits.

Aspect 3: The method of any of aspects 1 through 2, further comprising: measuring the empirical probability distribution across transmission of one or more shaped messages for a target duration.

Aspect 4: The method of any of aspects 1 and 3, further comprising: modulating the set of shaped bits to generate a set of modulated symbols, wherein the empirical probability distribution is an empirical probability distribution of respective amplitudes of the set of modulated symbols.

Aspect 5: The method of any of aspects 1 through 4, wherein the distribution closeness metric quantifies a difference between the empirical probability distribution and the target probability distribution.

Aspect 6: The method of aspect 5, wherein the distribution closeness metric is a Kullback-Leibler divergence score, an entropy difference, a total variation distance, a Hellinger distance, or a statistical distance.

Aspect 7: The method of any of aspects 1 through 4, wherein the distribution closeness metric quantifies a difference between respective moments of one or more orders of the empirical probability distribution and the target probability distribution.

Aspect 8: The method of any of aspects 1 through 7, further comprising: determining the threshold based at least in part on a parameter of the shaped message.

Aspect 9: The method of aspect 8, wherein the parameter is a number of modulation symbols in a shaping block, a number of bits in a shaping block, a shaping rate, a modulation order, or a combination thereof.

Aspect 10: The method of any of aspects 1 through 9, wherein transmitting the shaped message comprises: transmitting the shaped message in accordance with a first MPR associated with the shaped message different from a second MPR associated with uniform QAM.

Aspect 11: The method of any of aspects 1 through 10, further comprising: transmitting the shaped message in accordance with a first EVM associated with the shaped message different from a second EVM associated with uniform QAM.

Aspect 12: The method of any of aspects 1 through 11, further comprising: decoding the set of shaped bits; reconstructing a demodulation symbol based in part on the decoded set of shaped bits; and measuring an EVM associated with the shaped message based in part on an equalized probabilistic shaped transmitted waveform and the demodulation symbol.

Aspect 13: The method of any of aspects 1 through 12, further comprising: receiving signaling indicating the distribution closeness metric.

Aspect 14: The method of any of aspects 1 through 13, further comprising: receiving signaling indicating the target probability distribution.

Aspect 15: A method for wireless communication at a second wireless communication device, comprising: receiving, from a first wireless communication device, a shaped message; and outputting a signal indicating whether a distribution closeness metric between an empirical probability distribution of the shaped message and a target probability distribution of the shaped message satisfies a threshold.

Aspect 16: The method of aspect 15, further comprising: demodulating a set of shaped bits from the shaped message, wherein the empirical probability distribution is an empirical probability distribution of the set of shaped bits.

Aspect 17: The method of any of aspects 15 through 16, further comprising: measuring the empirical probability distribution across transmission of one or more shaped messages for a target duration.

Aspect 18: The method of any of aspects 15 and 17, wherein the empirical probability distribution is an empirical probability distribution of respective amplitudes of a set of modulated symbols of the shaped message.

Aspect 19: The method of any of aspects 15 through 18, wherein the distribution closeness metric quantifies a difference between the empirical probability distribution and the target probability distribution.

Aspect 20: The method of aspect 19, wherein the distribution closeness metric is a Kullback-Leibler divergence score, an entropy difference, a total variation distance, a Hellinger distance, or a statistical distance.

Aspect 21: The method of any of aspects 15 through 18, wherein the distribution closeness metric quantifies a difference between respective moments of one or more orders of the empirical probability distribution and the target probability distribution.

Aspect 22: The method of any of aspects 15 through 21, further comprising: determining the threshold based at least in part with a parameter of the shaped message.

Aspect 23: The method of aspect 22, wherein the parameter is a number of modulation symbols in a shaping block, a number of bits in a shaping block, a shaping rate, a modulation order, or a combination thereof.

Aspect 24: The method of any of aspects 15 through 23, further comprising: receiving signaling indicating the distribution closeness metric.

Aspect 25: The method of any of aspects 15 through 24, further comprising: receiving signaling indicating the target probability distribution.

Aspect 26: An apparatus for wireless communication at a first wireless communication device, comprising a processor; memory coupled with the processor; and instructions stored in the memory and executable by the processor to cause the apparatus to perform a method of any of aspects 1 through 14.

Aspect 27: An apparatus for wireless communication at a first wireless communication device, comprising at least one means for performing a method of any of aspects 1 through 14.

Aspect 28: A non-transitory computer-readable medium storing code for wireless communication at a first wireless communication device, the code comprising instructions executable by a processor to perform a method of any of aspects 1 through 14.

Aspect 29: An apparatus for wireless communication at a second wireless communication device, comprising a processor; memory coupled with the processor; and instructions stored in the memory and executable by the processor to cause the apparatus to perform a method of any of aspects 15 through 25.

Aspect 30: An apparatus for wireless communication at a second wireless communication device, comprising at least one means for performing a method of any of aspects 15 through 25.

Aspect 31: A non-transitory computer-readable medium storing code for wireless communication at a second wireless communication device, the code comprising instructions executable by a processor to perform a method of any of aspects 15 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first wireless communication device, comprising:
memory; and
at least one processor of the first wireless communication device, the at least one processor coupled with the memory and configured to:
perform probabilistic shaping on a set of information bits to generate a set of shaped bits in accordance with a target probability distribution; and
transmit, to a second wireless communications device, a shaped message generated based at least in part on the set of shaped bits, wherein a distribution closeness metric between an empirical probability distribution of the shaped message and the target probability distribution satisfies a threshold.

2. The apparatus of claim 1, wherein the empirical probability distribution is an empirical probability distribution of the set of shaped bits.

3. The apparatus of claim 1, wherein the at least one processor is further configured to:
measure the empirical probability distribution across transmission of one or more shaped messages for a target duration.

4. The apparatus of claim 1, wherein the at least one processor is further configured to:
modulate the set of shaped bits to generate a set of modulated symbols, wherein the empirical probability distribution is an empirical probability distribution of respective amplitudes of the set of modulated symbols.

5. The apparatus of claim 1, wherein the distribution closeness metric quantifies a difference between the empirical probability distribution and the target probability distribution.

6. The apparatus of claim 5, wherein the distribution closeness metric is a Kullback-Leibler divergence score, an entropy difference, a total variation distance, a Hellinger distance, or a statistical distance.

7. The apparatus of claim 1, wherein the distribution closeness metric quantifies a difference between respective moments of one or more orders of the empirical probability distribution and the target probability distribution.

8. The apparatus of claim 1, wherein the at least one processor is further configured to:
determine the threshold based at least in part on a parameter of the shaped message.

9. The apparatus of claim 8, wherein the parameter is a quantity of modulation symbols in a shaping block, a quantity of bits in a shaping block, a shaping rate, a modulation order, or a combination thereof.

10. The apparatus of claim 1, wherein the at least one processor configured to transmit the shaped message is further configured to:
transmit the shaped message in accordance with a first maximum power reduction associated with the shaped message different from a second maximum power reduction associated with uniform quadrature amplitude modulation.

11. The apparatus of claim 1, wherein the at least one processor is further configured to:
transmit the shaped message in accordance with a first error vector magnitude associated with the shaped message different from a second error vector magnitude associated with uniform quadrature amplitude modulation.

12. The apparatus of claim 1, wherein the at least one processor is further configured to:
decode the set of shaped bits;
reconstruct a demodulation symbol based in part on the decoded set of shaped bits; and
measure an error vector magnitude associated with the shaped message based in part on an equalized probabilistic shaped transmitted waveform and the demodulation symbol.

13. The apparatus of claim 1, wherein the at least one processor is further configured to:
receive signaling indicating the distribution closeness metric.

14. The apparatus of claim 1, wherein the at least one processor is further configured to:
receive signaling indicating the target probability distribution.

15. An apparatus for wireless communication at a second wireless communication device, comprising:
memory;
a transceiver; and
at least one processor of the second wireless communication device, the at least one processor coupled with the memory and the transceiver and configured to:
receive, via the transceiver from a first wireless communication device, a shaped message; and
output a signal indicating whether a distribution closeness metric between an empirical probability distribution of the shaped message and a target probability distribution of the shaped message satisfies a threshold.

16. The apparatus of claim 15, wherein the at least one processor further configured to:
demodulate a set of shaped bits from the shaped message, wherein the empirical probability distribution is an empirical probability distribution of the set of shaped bits.

17. The apparatus of claim 15, wherein the at least one processor further configured to:
measure the empirical probability distribution across transmission of one or more shaped messages for a target duration.

18. The apparatus of claim 15, wherein the empirical probability distribution is an empirical probability distribution of respective amplitudes of a set of modulated symbols of the shaped message.

19. The apparatus of claim 15, wherein the distribution closeness metric quantifies a difference between the empirical probability distribution and the target probability distribution.

20. The apparatus of claim 19, wherein the distribution closeness metric is a Kullback-Leibler divergence score, an entropy difference, a total variation distance, a Hellinger distance, or a statistical distance.

21. The apparatus of claim 15, wherein the distribution closeness metric quantifies a difference between respective moments of one or more orders of the empirical probability distribution and the target probability distribution.

22. The apparatus of claim 15, wherein the at least one processor further configured to:
determine the threshold based at least in part with a parameter of the shaped message.

23. The apparatus of claim 22, wherein the parameter is a quantity of modulation symbols in a shaping block, a quantity of bits in a shaping block, a shaping rate, a modulation order, or a combination thereof.

24. The apparatus of claim 15, wherein the at least one processor further configured to:
receive signaling indicating the distribution closeness metric.

25. The apparatus of claim 15, wherein the at least one processor further configured to:
receive signaling indicating the target probability distribution.

26. A method for wireless communication at a first wireless communication device, comprising:
performing probabilistic shaping on a set of information bits to generate a set of shaped bits in accordance with a target probability distribution; and
transmitting, to a second wireless communications device, a shaped message generated based at least in part on the set of shaped bits, wherein a distribution closeness metric between an empirical probability distribution of the shaped message and the target probability distribution satisfies a threshold.

27. The method of claim 26, wherein the empirical probability distribution is an empirical probability distribution of the set of shaped bits.

28. The method of claim 26, further comprising:
measuring the empirical probability distribution across transmission of one or more shaped messages for a target duration.

29. The method of claim 26, further comprising:
modulating the set of shaped bits to generate a set of modulated symbols, wherein the empirical probability distribution is an empirical probability distribution of respective amplitudes of the set of modulated symbols.

30. The method of claim 26, wherein the distribution closeness metric quantifies a difference between the empirical probability distribution and the target probability distribution.

31. The method of claim 30, wherein the distribution closeness metric is a Kullback-Leibler divergence score, an entropy difference, a total variation distance, a Hellinger distance, or a statistical distance.

32. The method of claim 26, wherein the distribution closeness metric quantifies a difference between respective moments of one or more orders of the empirical probability distribution and the target probability distribution.

33. The method of claim 26, further comprising:
determining the threshold based at least in part on a parameter of the shaped message, wherein the parameter is a quantity of modulation symbols in a shaping block, a quantity of bits in a shaping block, a shaping rate, a modulation order, or a combination thereof.

34. The method of claim 26, wherein transmitting the shaped message comprises:
transmitting the shaped message in accordance with a first maximum power reduction associated with the shaped message different from a second maximum power reduction associated with uniform quadrature amplitude modulation.

35. The method of claim 26, further comprising:
transmitting the shaped message in accordance with a first error vector magnitude associated with the shaped message different from a second error vector magnitude associated with uniform quadrature amplitude modulation.

36. The method of claim 26, further comprising:
decoding the set of shaped bits;
reconstructing a demodulation symbol based in part on the decoded set of shaped bits; and
measuring an error vector magnitude associated with the shaped message based in part on an equalized probabilistic shaped transmitted waveform and the demodulation symbol.

37. A method for wireless communication at a second wireless communication device, comprising:
receiving, from a first wireless communication device, a shaped message; and
outputting a signal indicating whether a distribution closeness metric between an empirical probability distribution of the shaped message and a target probability distribution of the shaped message satisfies a threshold.

38. The method of claim 37, wherein the distribution closeness metric quantifies a difference between the empirical probability distribution and the target probability distribution.

39. The method of claim 37, wherein the distribution closeness metric quantifies a difference between respective moments of one or more orders of the empirical probability distribution and the target probability distribution.

40. An apparatus for wireless communication at a first wireless communication device, comprising:
means for performing probabilistic shaping on a set of information bits to generate a set of shaped bits in accordance with a target probability distribution; and
means for transmitting, to a second wireless communications device, a shaped message generated based at least in part on the set of shaped bits, wherein a distribution closeness metric between an empirical probability distribution of the shaped message and the target probability distribution satisfies a threshold.

41. The apparatus of claim 40, wherein the distribution closeness metric quantifies a difference between the empirical probability distribution and the target probability distribution.

42. The apparatus of claim 40, wherein the distribution closeness metric quantifies a difference between respective moments of one or more orders of the empirical probability distribution and the target probability distribution.

43. A non-transitory computer-readable medium storing code for wireless communication at a first wireless communication device, the code comprising instructions executable by a processor to:
perform probabilistic shaping on a set of information bits to generate a set of shaped bits in accordance with a target probability distribution; and
transmit, to a second wireless communications device, a shaped message generated based at least in part on the set of shaped bits, wherein a distribution closeness metric between an empirical probability distribution of the shaped message and the target probability distribution satisfies a threshold.

44. The non-transitory computer-readable medium of claim 43, wherein the distribution closeness metric quantifies a difference between the empirical probability distribution and the target probability distribution.

45. The non-transitory computer-readable medium of claim 43, wherein the distribution closeness metric quantifies a difference between respective moments of one or more orders of the empirical probability distribution and the target probability distribution.
